(19) United States
(12) Patent Application Publication
(10) Pub. No.: US 2016/0241141 A1
(43) Pub. Date: Aug. 18, 2016

(54) VOLTAGE GENERATOR

(71) Applicant: SK hynix Inc., Gyeonggi-do (KR)

(72) Inventors: Jong-Man IM, Gyeonggi-do (KR); Woong-Kyu CHOI, Gyeonggi-do (KR)

(21) Appl. No.: 14/743,781

(22) Filed: Jun. 18, 2015

(30) Foreign Application Priority Data
Feb. 12, 2015 (KR) 10-2015-0021434

(51) Int. Cl. H02M 3/07

(52) U.S. Cl. CPC H02M 3/073

(57) ABSTRACT

A voltage generator may include: an internal voltage generation unit suitable for generating an internal voltage by pumping an external voltage in response to a pumping cycle signal; and a capacitance adjusting unit comprising a capacitive element which receives and transmits the pumping cycle signal to the internal voltage generation unit, and is suitable for adjusting a capacitance of the capacitive element based on the external voltage.

### CROSS-REFERENCE TO RELATED APPLICATIONS

The present application claims priority of Korean Patent Application No. 10-2015-0021434, filed on Feb. 12, 2015, which is incorporated herein by reference in its entirety.

### BACKGROUND

1. Field

This patent document relates to a voltage generator and, more particularly, to a pumping circuit including a capacitive element.

2. Description of the Related Art

Power supply voltages and ground voltages are provided to semiconductor devices from an external source. To perform internal operations, semiconductor devices generate and use a variety of internal voltages other than the power supply voltage VDD. Internal voltages between the power supply voltage VDD and the ground voltage VSS are generated through a regulator circuit. On the other hand, internal voltages of higher potential than the power supply voltage VDD or lower potential than the ground voltage VSS are generated through pumping circuits. For example, the internal voltage generated through the pumping circuit may include a high voltage VPP, a core voltage VCORE, a substrate bias voltage VBB and the like.

Semiconductor devices using pumping circuits set a target level for the internal voltage, and detect whether the internal voltage exceeds the target level. When the internal voltage does not reach the target level, the semiconductor device pumps the internal voltage through the pumping circuit. Since the voltage pumping ability of semiconductor devices is determined by the storage capacity of a capacitor included in the pumping circuit, if the voltage is not high enough, the storage capacity of the capacitor must be increased.

In general, a Metal Oxide Semiconductor (MOS)-type capacitor is used in the pumping circuit. Per unit area, cell-type capacitors may realize higher capacitances than MOS-type capacitors. However, when a high voltage is applied to cell-type capacitors, an oxide layer that is present may be destroyed. Thus, although MOS-type capacitors have less capacitance than cell-type capacitors, the horizontal area to accommodate MOS-type capacitors may be expanded to increase the storage capacity. Recently, however, highly integrated semiconductor devices have encountered limitations in increasing the amount of area that can be dedicated to pumping circuit capacitors.

### SUMMARY

Various embodiments are directed to a voltage generator which includes a capacitive element having a high capacitance without increased area.

In an embodiment, a voltage generator may include: an internal voltage generation unit suitable for generating an internal voltage by pumping an external voltage in response to a pumping cycle signal; and a capacitance adjusting unit comprising a capacitive element which receives and transmits the pumping cycle signal to the internal voltage generation unit, and is suitable for adjusting a capacitance of the capacitive element based on the external voltage.

The capacitive element may comprise a plurality of capacitors coupled in series.

The capacitance adjusting unit may further comprise: a voltage sensor suitable for sensing the external voltage and generating a control signal corresponding to the external voltage; and a selector suitable for determining the number of the capacitors in response to the control signal.

The selector may comprise a plurality of switches that are driven in response to the control signal and are coupled in parallel to the respective capacitors.

The plurality of capacitors may include a plurality of cell-type capacitors.

The number of the capacitors may be determined in response to the external voltage and a maximum voltage that oxide layers of the capacitors can withstand.

The internal voltage generation unit may generate the internal voltage by performing a double charge pumping operation.

The internal voltage generation unit may generate the internal voltage by performing a triple charge pumping operation.

In an embodiment, a voltage generator may include: a detection unit suitable for generating a detection signal by comparing a reference voltage with a first internal voltage; an oscillation unit suitable for generating a pumping cycle signal in response to the detection signal; a pumping unit suitable for generating a second internal voltage by pumping the first internal voltage in response to the pumping cycle signal; and a capacitance adjusting unit comprising a plurality of capacitors coupled in series, which transmit the pumping cycle signal to the pumping unit from the oscillation unit, and suitable for adjusting the number of the capacitors based on the first internal voltage.

The capacitance adjusting unit may further comprise: a voltage sensor suitable for sensing the first internal voltage and generating a control signal corresponding to the first internal voltage; and a selector suitable for determining the number of the capacitors in response to the control signal.

The selector may comprise a plurality of switches which are driven in response to the control signal, and coupled in parallel to the respective capacitors.

The plurality of capacitors may include a plurality of cell-type capacitors.

The number of the capacitors may be determined in response to the first internal voltage and a maximum voltage that oxide layers of the capacitors can withstand.

The pumping unit may generate the second internal voltage by performing a double charge pumping operation.

The pumping unit may generate the second internal voltage by performing a triple charge pumping operation.

In an embodiment, a voltage generator may include: a detection unit suitable for generating a detection signal by comparing a reference voltage with a first internal voltage; an oscillation unit suitable for generating a pumping cycle signal in response to the detection signal; a pumping unit suitable for generating a second internal voltage by pumping the first internal voltage in response to the pumping cycle signal; and a capacitance adjusting unit comprising a plurality of capacitors coupled in series, which transmit the pumping cycle signal to the pumping unit from the oscillation unit, and suitable for adjusting the number of the capacitors based on the first internal voltage, wherein the capacitance adjusting unit comprises a plurality of switches which are coupled in parallel to the respective capacitors, and selects the plurality of capacitors based on the first internal voltage.

The capacitance adjusting unit may further comprise: a voltage sensor suitable for sensing the first internal voltage and generating a control signal for controlling the plurality of switches.

The number of the capacitors may be determined in response to the first internal voltage and a maximum voltage that oxide layers of the capacitors can withstand.

The pumping unit may generate the second internal voltage by performing a double charge pumping operation.

The pumping unit may generate the second internal voltage by performing a triple charge pumping operation.

### BRIEF DESCRIPTION OF THE DRAWINGS

FIG. 1 is a block diagram illustrating a voltage generator in accordance with an embodiment of the present invention.

FIG. 2 is a detailed block diagram illustrating a capacitance adjusting unit illustrated in FIG. 1.

FIG. 3 is a circuit diagram illustrating a first embodiment of the voltage generator of FIG. 1.

FIG. 4 is a circuit diagram illustrating a second embodiment of the voltage generator of FIG. 1.

FIG. 5 is a table for describing a capacitance gain of the voltage generator illustrated in FIG. 1.

FIG. 6 is a block diagram illustrating an oscillator for generating a first pumping cycle signal of FIG. 1.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, reference numerals correspond directly to the like numbered parts in the various figures and embodiments of the present invention. It is also noted that in this specification, “connected/coupled” refers to one component not only directly coupling another component but also indirectly coupling another component through an intermediate component. In addition, a singular form may include a plural form as long as it is not specifically mentioned.

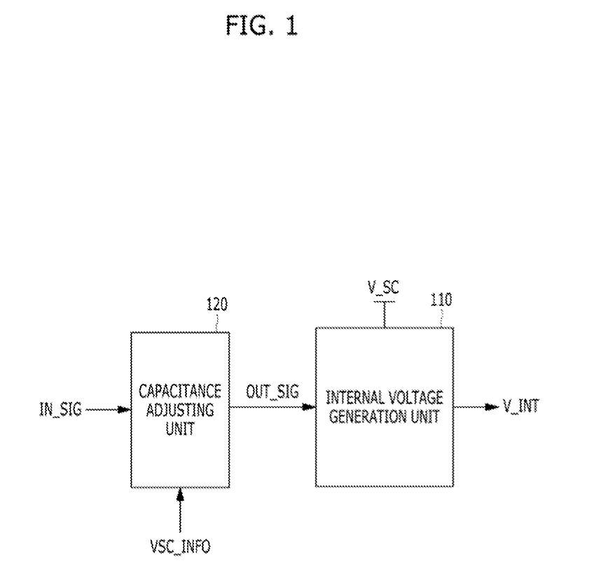

FIG. 1 is a block diagram illustrating a voltage generator in accordance with an embodiment of the present invention.

Referring to FIG. 1, the voltage generator may include an internal voltage generation unit 110 and a capacitance adjusting unit 120.

The internal voltage generation unit 110 may generate an internal voltage V_INT by pumping a source voltage V_SC. The internal voltage V_INT may be obtained by increasing a voltage level of the source voltage V_SC by a value corresponding to a preset target level. For example, the internal voltage V_INT may include a high voltage VPP, a core voltage VCORE, a substrate bias voltage VBB, and a negative word line voltage VBBW. In an embodiment, the source voltage V_SC may be an external voltage inputted from outside. In another embodiment, the source voltage V_SC may be an internal voltage generated by using a reference voltage.

The capacitance adjusting unit 120 may receive source voltage information VSC_INFO indicating information on the source voltage V_SC from outside. The capacitance adjusting unit 120 may receive a first pumping cycle signal IN_SIG with a predetermined cycle, which is generated through an oscillator (not illustrated). The capacitance adjusting unit 120 may include a capacitive element (not illustrated). The capacitive element may include a plurality of cell-type capacitors coupled in series.

The capacitance adjusting unit 120 may sense the voltage level of the source voltage V_SC based on the source voltage information VSC_INFO, and adjust the capacitance of the capacitive element in response to the sensed voltage level. Thus, the capacitance adjusting unit 120 may determine the number of capacitors, among the plurality of cell-type capacitors, in response to the sensed voltage level. The capacitance adjusting unit 120 may transmit the first pumping cycle signal IN_SIG as a second pumping cycle signal OUT_SIG to the internal voltage generation unit 110, based on the determined capacitor number.

In general, when a plurality of capacitors are coupled in series, the total capacitance decreases. For example, when two capacitors C₁ and C₂ are coupled in series, total capacitance C_{T} may be expressed as Equation 1.

$$\frac{1}{{C}_{T}} = \frac{1}{{C}_{1}} + \frac{1}{{C}_{2}} \qquad [ Equation 1 ]$$

Assuming that the two capacitors C₁ and C₂ have the same capacity, the following equations may be established.

$${C}_{1} = {C}_{2} = {C}_{S}$$

$$\frac{1}{{C}_{T}} = \frac{2}{{C}_{S}}$$

$${C}_{T} = \frac{{C}_{S}}{2}$$

That is, the total capacitance C_{T} has a value corresponding to half of the capacitance of one capacitor C_{S}.

Furthermore, when a high voltage is applied to a cell-type capacitor, an oxide layer of the capacitor may be destroyed. The maximum voltage within a range where the oxide layer of the capacitor is not destroyed may be represented by V_{C1} and may be expressed as Equation 2.

$$\frac{Vsc - Vss}{N} \leq {V}_{C 1} \qquad [ Equation 2 ]$$

Here, V_{SC} denotes a source voltage of the internal voltage generation unit 110, V_{SS} denotes a ground voltage, and N denotes the number of capacitors coupled in series. As expressed through Equation 2, the maximum voltage V_{C1} may be decreased when the capacitor number N is increased. Thus, a voltage which is handled by one capacitor may be reduced.

That is, although a higher capacitance may be secured as the capacitor number N decreases, the voltage handled by one capacitor may be increased, thereby reducing voltage durability. Thus, the capacitance adjusting unit 120 may set the capacitor number N according to the source voltage V_{SC} and the maximum voltage V_{C1} of the capacitor.

The voltage generator in accordance with the embodiment of the present invention may use cell-type capacitors having a larger charging capacity than MOS-type capacitors, and determine the number of capacitors coupled in series within a range that satisfies the voltage durability of the capacitor. That is, since the voltage generator secures a high capacitance without increased area, the pumping driving ability of the internal voltage generation unit 110 may be improved.

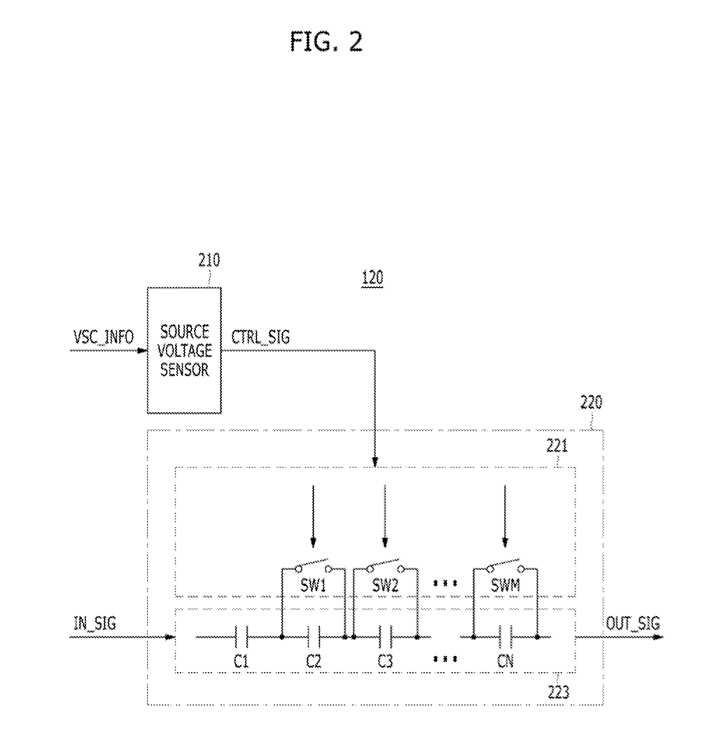

FIG. 2 is a detailed block diagram illustrating the capacitance adjusting unit 120 illustrated in FIG. 1.

Referring to FIG. 2, the capacitance adjusting unit 120 may include a source voltage sensor 210 and a pumping controller 220. The pumping controller 220 may include a selector 221 and a capacitive element 223. The capacitive element 223 may include a plurality of cell-type capacitors C1 to CN coupled in series.

The source voltage sensor 210 may receive the source voltage information VSC_INFO. The source voltage sensor 210 may sense the voltage level of the source voltage (V_SC of FIG. 1), based on the source voltage information VSC_INFO. The source voltage sensor 210 may generate a control signal CTRL_SIG corresponding to the source voltage V_SC. The control signal CTRL_SIG may include a digital code signal for controlling the selector 221.

The selector 221 may include a plurality of switches SW1 to SWM. The plurality of switches SW1 to SWM may be coupled in parallel to the respective capacitors C2 to CN, and driven in response to the control signal CTRL_SIG. Here, N and M are positive integers, and N is greater than M. Though FIG. 2 shows that the number of the switches SW1 to SWM is smaller than the number of the capacitors C2 to CN, the present invention is not limited thereto, but may include a plurality of switches SW1 to SWN which are coupled in parallel to the respective capacitors C1 to CN, one to one, and driven in response to the control signal CTRL_SIG.

The capacitive element 223 may receive the first pumping cycle signal IN_SIG through at least one capacitor whose number is determined in response to turning-on/off the plurality of switches SW1 to SWM, among the plurality of capacitors C1 to CN, and output a second pumping cycle signal OUT_SIG.

For example, when the voltage level of the source voltage V_SC is increased, the selector 221 may turn off the plurality of switches SW1 to SWM, and the capacitive element 223 may drive the plurality of capacitors C1 to CN to receive the first pumping cycle signal IN_SIG and output the second pumping cycle signal OUT_SIG to the internal voltage generation unit (110 of FIG. 1).

On the other hand, when the voltage level of the source voltage V_SC is decreased, the selector 221 may turn on the plurality of switches SW1 and SWM. The plurality of switches SW1 to SWM may be shorted to drive only one capacitor C1. The capacitive element 223 may receive the first pumping cycle signal IN_SIG and output the second pumping cycle signal OUT_SIG to the internal voltage generation unit 110.

That is, the capacitance adjusting unit 120 may sense the voltage level of the source voltage V_SC and selectively adjust the number of the capacitors C1 to CN such that the capacitors have a high capacitance within the range where the oxide layers of the capacitors are not destroyed.

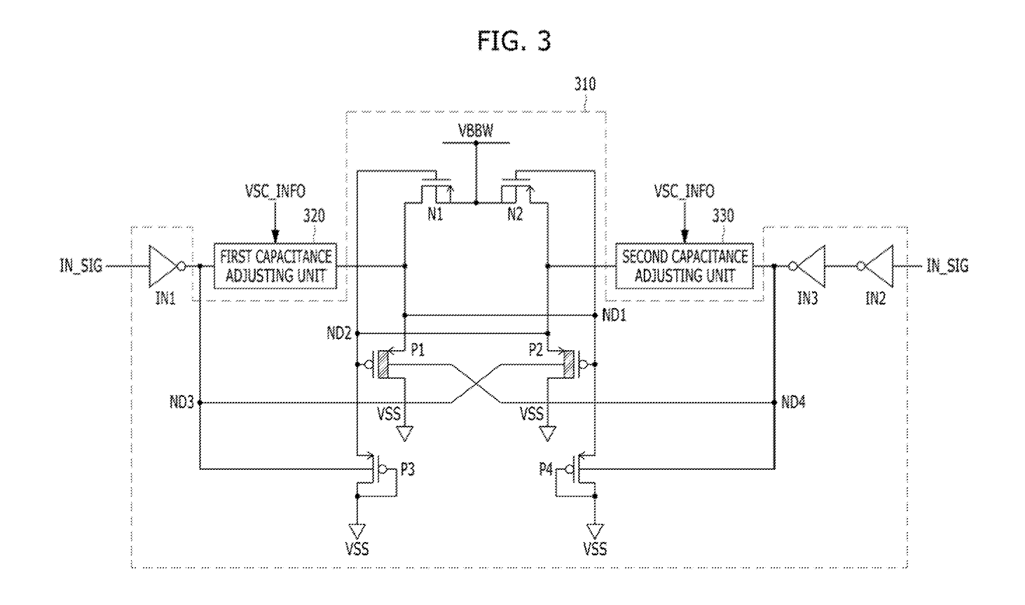

FIG. 3 is a circuit diagram illustrating a first embodiment of the voltage generator of FIG. 1.

Referring to FIG. 3, the voltage generator may include an internal voltage generation unit 310, a first capacitance adjusting unit 320, and a second capacitance adjusting unit 330.

The internal voltage generation unit 310 may be implemented with a doubler charge pumping circuit, and generate a negative word line voltage VBBW through a charge pumping operation.

The internal voltage generation unit 310 may include first and second NMOS transistors N1 and N2, first to fourth PMOS transistors P1 to P4, and first to third inverters IN1 and IN3.

The first and second NMOS transistors N1 and N2 may be coupled between first and second nodes ND1 and ND2. The first NMOS transistor N1 may have a gate coupled to the second node ND2, and the second NMOS transistor N2 may have a gate coupled to the first node ND1. A negative word line voltage (VBBW) terminal may be coupled to a common node of the first and second nodes ND1 and ND2. The first and second PMOS transistors P1 and P2 may be coupled between the first and second NMOS transistors N1 and N2 and a ground voltage (VSS) terminal, respectively, to be cross-coupled between the first and second nodes ND1 and ND2 and third and fourth nodes ND3 and ND4. The third and fourth PMOS transistors P3 and P4 may be coupled between the first and second nodes ND1 and ND2 and the ground voltage (VSS) terminal, respectively, and the third and fourth PMOS transistors P3 and P4 may have gates coupled to the ground voltage (VSS) terminal. The third and fourth PMOS transistors P3 and P4 may receive a ground voltage VSS through the gates thereof, and maintain a turn-on state at all times.

The first and second capacitance adjusting units 320 and 330 may have substantially the same configuration as the capacitance adjusting unit 120 illustrated in FIG. 2.

The first capacitance adjusting unit 320 may have a first terminal coupled to the first inverter IN1 and the third node ND3, and a second terminal coupled to the first node ND1. The first capacitance adjusting unit 320 may amplify and output the pumping cycle signal IN_SIG inverted by the first inverter IN1 based on the source voltage information VSC_INFO indicating information on the source voltage (not illustrated) from outside.

The second capacitance adjusting unit 330 may have a first terminal coupled to the third inverter IN3 and the fourth node ND4, and a second terminal coupled to the second node ND2. The second capacitance adjusting unit 330 may amplify and output the pumping cycle signal IN_SIG, which is not inverted by the second and third inverters IN2 and IN3 based on the source voltage information VSC_INFO indicating information on the source voltage (not illustrated) from outside.

For example, suppose that the source voltage V_{SC} of the internal voltage generation unit 310 for generating a negative word line voltage VPPW is 1.2V and the maximum voltage V_{C1} that an oxide layer of one capacitor included in the first and second capacitance adjusting units 320 and 330 can withstand is 1V.

$$\frac{Vsc - Vss}{{V}_{C 1}} \leq N \qquad [ Equation 3 ]$$

According to Equation 3, each of the first and second capacitance adjusting units 320 and 330 may determine the number of capacitors to be 1.2 or more, that is, two capacitors coupled in series. Thus, the first and second capacitance adjusting units 320 and 330 may select two capacitors among the plurality of capacitors coupled in series, thereby securing high capacitance within a range where that the oxide layers of the capacitors can withstand. Furthermore, the first and second capacitance adjusting units 320 and 330 may have a smaller area but a higher capacitance than MOS-type capacitors.

When the third and fourth PMOS transistors P3 and P4 are turned on, the ground voltage VSS may be supplied to the first and second nodes ND1 and ND2 to drive the first and second PMOS transistors P1 and P2. At this time, the pumping cycle signal IN_SIG toggling between voltage levels of a power supply voltage VDD and the ground voltage VSS may be applied from an oscillation unit (not illustrated).

When the pumping cycle signal IN_SIG transitions from a low level corresponding to the ground voltage VSS to a high level corresponding to the power supply voltage VDD, the potential of the second node ND2 may be momentarily raised by the second capacitance adjusting unit 330. On the other hand, the potential of the first node ND1 may be momentarily lowered by the first capacitance adjusting unit 320.

As the second node ND2 is discharged by the second PMOS transistor P2 during a period in which the pumping cycle signal IN_SIG is maintained at a high level, the potential of the second node ND2 may gradually drop. On the other hand, the potential of the first node ND1 may gradually rise, as charge transfer is performed by the first NMOS transistor N1. Thus, when a voltage difference between the first and second nodes ND1 and ND2 gradually decreases to reach a threshold voltage of the second PMOS transistor P2, the voltage drop of the second node ND2 may be stopped. Furthermore, when the voltage difference between the first and second nodes ND1 and ND2 reaches a threshold voltage of the first NMOS transistor N1, the first NMOS transistor N1 may be turned off to stop the voltage rise of the first node ND1.

Then, when the pumping cycle signal IN_SIG transitions from a high level to a low level, the potential of the second node ND2 may momentarily drop, and the potential of the first node ND1 may momentarily rise. Furthermore, charge transfer may be performed by the second NMOS transistor N2, and the above-described process may be repeated.

Thus, when the pumping cycle signal IN_SIG transitions from a low level to a high level and transitions from the high level to the low level, charge transfer may alternately occur in the first and second nodes ND1 and ND2. As charges are released to the ground voltage (VSS) terminal from the negative word line voltage (VBBW) terminal, the potential of the negative word line voltage (VBBW) terminal may be gradually lowered to a negative value.

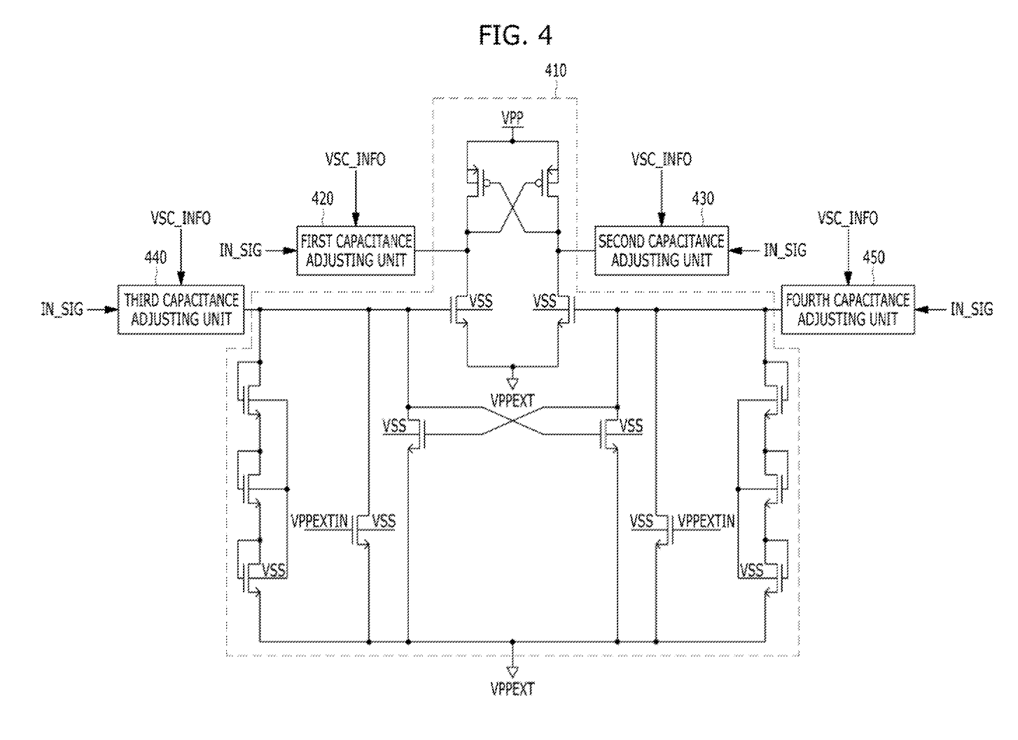

FIG. 4 is a circuit diagram illustrating a second embodiment of the voltage generator of FIG. 1.

Referring to FIG. 4, the voltage generator may include an internal voltage generation unit 410 and first to fourth capacitance adjusting units 420 to 450.

The internal voltage generation unit 410 may be implemented with a doubler charge pumping circuit, and generate a high voltage VPP through a charge pumping operation. The internal voltage generation unit 410 may perform a pumping operation for generating the high voltage VPP in response to pumping cycle signals outputted from the first to fourth capacitance adjusting units 420 to 450. The internal voltage generation unit 410 may be configured and operated in the same manner as a doubler-type pumping circuit for generating the high voltage VPP.

The first to fourth capacitance adjusting units 420 to 450 may have the same configuration as the capacitance adjusting unit illustrated in FIG. 2.

Each of the first to fourth capacitance adjusting units 420 to 450 may have one terminal configured to receive a pumping cycle signal IN_SIG transmitted from an oscillation unit (not illustrated) and the other second terminal coupled to the internal voltage generation unit 410. The first to fourth capacitance adjusting units 420 to 450 may amplify the pumping cycle signal IN_SIG based on the source voltage information VSC_INFO indicating information on the source voltage (not illustrated) from outside and output the amplified signal to the internal voltage generation unit 410.

For example, suppose that the source voltage V_{SC} of the internal voltage generation unit 410 for generating the high voltage VPP is 2.5V and the maximum voltage V_{C1} that the oxide layer of the capacitors included in the first and second capacitance adjusting units 320 and 330 can withstand is 1V.

$$\frac{Vsc - Vss}{{V}_{C 1}} \leq N \qquad [ Equation 4 ]$$

According to Equation 4, each of the first to fourth capacitance adjusting units 420 to 450 may determine the number of capacitors as 2.5 or more, that is, three capacitors coupled in series, among the plurality of capacitors therein. Thus, the first to fourth capacitance adjusting units 420 to 450 may select three capacitors among the plurality of capacitors coupled in series, thereby securing a high capacitance within a range that the oxide layers of the capacitors can withstand. Furthermore, the first to fourth capacitance adjusting units 420 to 450 may have a smaller area but a higher capacitance than MOS-type capacitors.

As described above, the voltage generators of FIGS. 3 and 4 may include the internal voltage generation unit implemented with a doubler circuit for performing a double charge pumping operation. However, the present invention is not limited thereto, and may be applied to a tripler circuit for performing a triple charge pumping operation which pumps an internal voltage three times according to the target level of the internal voltage.

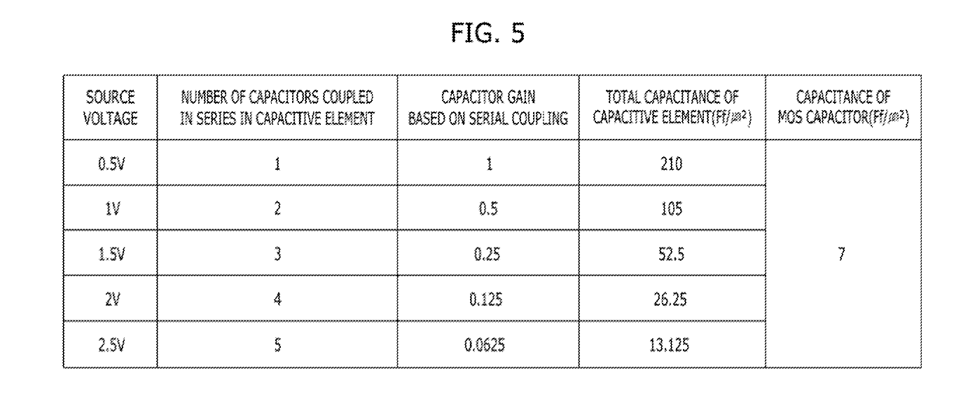

FIG. 5 is a table for describing a capacitance gain of the voltage generator illustrated in FIG. 1.

Referring to FIG. 5, the table shows the number of capacitors coupled in series in a capacitive element according to a source voltage, a capacitance gain based on a serial coupling, and a total capacitance of the capacitive element, when it is assumed that the maximum voltage that the oxide layer of a unit capacitor included in the capacitive element can withstand is 0.5V.

The cell-type capacitor of the capacitive element may have a capacity 30 times greater than an MOS-type capacitor, per unit area. For example, suppose that the capacity of an MOS-type capacitor utilizing the same area is 7 fF/um².

As the source voltage increases, the number of capacitors selected in the capacitive element increases. Furthermore, as the source voltage increases, the total capacitance of the capacitive element decreases. However, the capacitive element may have a higher capacitance per unit area than that of the MOS-type capacitor. Thus, in a conventional voltage generator using MOS-type capacitors, the area of the capacitor region needs to be increased to have the same capacitance as cell-type capacitors. However, the voltage generator in accordance with the embodiment of the present invention may a secure high capacitance even though the area is not increased. Thus, the voltage generator may improve the pumping driving ability of the pumping circuit.

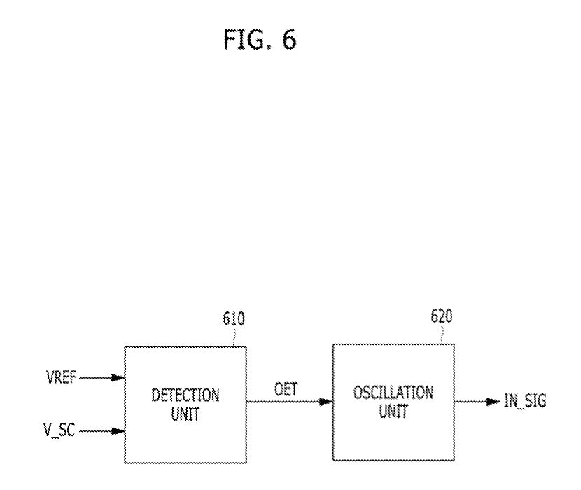

FIG. 6 is a block diagram illustrating an oscillator for generating the first pumping cycle signal IN_SIG of FIG. 1.

Referring to FIG. 6, the oscillator may include a detection unit 610 and an oscillation unit 620. The detection unit 610 may generate a detection signal DET by comparing a reference voltage VREF with a source voltage V_SC. The oscillation unit 620 may generate the first pumping cycle signal IN_SIG in response to the detection signal DET. For reference, the first pumping cycle signal IN_SIG toggles between voltage levels of a power supply voltage VDD and a ground voltage VSS.

In accordance with the embodiments of the present invention, the power generator circuit may secure high capacitance without increased area, thereby improving pumping driving ability.

Although various embodiments have been described for illustrative purposes, it will be apparent to those skilled in the art that various changes and modifications may be made without departing from the spirit and scope of the invention as defined in the following claims.

For example, the positions and types of logic gates and transistors used in the above-described embodiments may be set in different manners according to the polarities of input signals.

What is claimed is:

1. A voltage generator comprising:
an internal voltage generation unit suitable for generating an internal voltage by pumping an external voltage in response to a pumping cycle signal; and
a capacitance adjusting unit comprising a capacitive element which receives and transmits the pumping cycle signal to the internal voltage generation unit, and is suitable for adjusting a capacitance of the capacitive element based on the external voltage.

2. The voltage generator of claim 1, wherein the capacitive element comprises a plurality of capacitors coupled in series.

3. The voltage generator of claim 2, wherein the capacitance adjusting unit further comprises:
a voltage sensor suitable for sensing the external voltage and generating a control signal corresponding to the external voltage; and
a selector suitable for determining the number of the capacitors in response to the control signal.

4. The voltage generator of claim 3, wherein the selector comprises a plurality of switches that are driven in response to the control signal and are coupled in parallel to the respective capacitors.

5. The voltage generator of claim 2, wherein the plurality of capacitors includes a plurality of cell-type capacitors.

6. The voltage generator of claim 1, wherein the number of the capacitors is determined in response to the external voltage and a maximum voltage that oxide layers of the capacitors can withstand.

7. The voltage generator of claim 1, wherein the internal voltage generation unit generates the internal voltage by performing a double charge pumping operation.

8. The voltage generator of claim 1, wherein the internal voltage generation unit generates the internal voltage by performing a triple charge pumping operation.

9. A voltage generator comprising:
a detection unit suitable for generating a detection signal by comparing a reference voltage with a first internal voltage;
an oscillation unit suitable for generating a pumping cycle signal in response to the detection signal;
a pumping unit suitable for generating a second internal voltage by pumping the first internal voltage in response to the pumping cycle signal; and
a capacitance adjusting unit comprising a plurality of capacitors coupled in series, which transmit the pumping cycle signal to the pumping unit from the oscillation unit, and suitable for adjusting the number of the capacitors based on the first internal voltage.

10. The voltage generator of claim 9, wherein the capacitance adjusting unit further comprises:
a voltage sensor suitable for sensing the first internal voltage and generating a control signal corresponding to the first internal voltage; and
a selector suitable for determining the number of the capacitors in response to the control signal.

11. The voltage generator of claim 10, wherein the selector comprises a plurality of switches which are driven in response to the control signal, and coupled in parallel to the respective capacitors.

12. The voltage generator of claim 9, wherein the plurality of capacitors include a plurality of cell-type capacitors.

13. The voltage generator of claim 9, wherein the number of the capacitors is determined in response to the first internal voltage and a maximum voltage that oxide layers of the capacitors can withstand.

14. The voltage generator of claim 9, wherein the pumping unit generates the second internal voltage by performing a double charge pumping operation.

15. The voltage generator of claim 9, wherein the pumping unit generates the second internal voltage by performing a triple charge pumping operation.

16. A voltage generator comprising:
a detection unit suitable for generating a detection signal by comparing a reference voltage with a first internal voltage;
an oscillation unit suitable for generating a pumping cycle signal in response to the detection signal;
a pumping unit suitable for generating a second internal voltage by pumping the first internal voltage in response to the pumping cycle signal; and
a capacitance adjusting unit comprising a plurality of capacitors coupled in series, which transmit the pumping cycle signal to the pumping unit from the oscillation unit, and suitable for adjusting the number of the capacitors based on the first internal voltage,
wherein the capacitance adjusting unit comprises a plurality of switches which are coupled in parallel to the respective capacitors, and selects the plurality of capacitors based on the first internal voltage.

17. The voltage generator of claim 16, wherein the capacitance adjusting unit further comprises:
a voltage sensor suitable for sensing the first internal voltage and generating a control signal for controlling the plurality of switches.

18. The voltage generator of claim 16, wherein the number of the capacitors is determined in response to the first internal voltage and a maximum voltage that oxide layers of the capacitors can withstand.

19. The voltage generator of claim 16, wherein the pumping unit generates the second internal voltage by performing a double charge pumping operation.

20. The voltage generator of claim 16, wherein the pumping unit generates the second internal voltage by performing a triple charge pumping operation.
